(19) United States
(12) Patent Application Publication
(10) Pub. No.: US 2002/0032599 A1
(43) Pub. Date: Mar. 14, 2002

(54) System and method for venture acceleration

(76) Inventors: W. Jeffrey Chandler, Scottsdale, AZ (US); Alan Philip Hald, Phoenix, AZ (US); Quinn Williams, P. Valley, AZ (US)

Correspondence Address: W. Jeff Chandler, 10186 E Kalil Dr., Scottsdale, AZ, 85260, US

(21) Appl. No.: 09/834,175

(22) Filed: Apr. 12, 2001

Related U.S. Application Data
(60) Provisional application No. 60/196,500, filed on Apr. 12, 2000.

(51) Int. Cl. G06F 17/60

(52) U.S. Cl. 705/10; 705/14

(57) ABSTRACT

A web-centric application which acts as a beacon for an entrepreneurial and venture capital community or series of communities that offers a plurality of interactive products that primarily profile, map and match needs to capabilities for new and improved methods for venture incubation and acceleration. A set of interactive business planning and management tools, and, access to capital, investments, strategic alliances, and mergers and acquisitions that offer electronic access and downloadable hard copy within a private self-contained profiling system that maximizes business efficiencies. A method for the formulation of a virtual local community through one or a series of nodes that are capable of being connected through a central point or associated links in order to enhance and expand knowledge-bases, services, networks and business opportunities. A method for collaboration and networking amongst the members within the local community(s).

### CROSS-REFERENCE

This application claims priority from U.S. Provisional Patent application no. 60/196,500 filed on Apr. 12, 2000.

### BACKGROUND OF THE INVENTION

1. Field of Invention

The present invention relates generally to a venture accelerator, and more particularly, to a web-based venture matching accelerator, and even more particularly to a comprehensive web-based business venture matching and resource center.

2. Discussion of Related Art

The problem with current business of incubation and acceleration within the entrepreneurial and venture capital community is fragmentation, inconsistent access to capital, and quality investment opportunities in and outside normal networks, and marginal collaboration channels. The three primary elements that make up the backbone of this industry are the entrepreneurs, investors, and professional services. Most communities lack a sophisticated system or network to properly support a positive growth factor. Current firms skilled in the art that offer web-centric means have overlooked the need for a unified and comprehensive approach at the local community level that consolidates the respective supply chain, and that can be readily accessed by its urban and rural members. Additionally, others that offer a related art have not realized the need to create a series of local nodes that may connect to one another in order to expand business opportunities and networks.

The entrepreneur is often faced with a vision that is difficult to articulate and navigate. Independent of their experience levels and company stage, the demanding requirement to access, map, and match the entrepreneurs needs to resource capabilities poses a significant challenge and is critical in growing a successful organization. In other words, the entrepreneur approaches this daunting task without a well documented set of guidelines and the chances for success are dramatically reduced. Current firms have not realized the need to provide a knowledge-base, and interactive business planning and operational management tool set that may provide guidelines to enhance and grow a business. Additionally, current firms have not identified the need to gather a comprehensive interactive offering of the critical organizations within a community and their elements that are specific and pertinent to the entrepreneurial companies. These entities include professional services, academic institutions, economic development agencies, and trade organizations.

Financial capital members (e.g. angels, venture capitalists, institutional banking, corporate development) that provide investments, strategic alliances, and mergers and acquisitions are challenged to opportunities in and outside of their networks. Current firms have not realized the need to provide a sophisticated system and method to create greater qualified opportunities and expand networks.

Technology transfer from academic institutions and the private sector have poor promotional channels. Current firms have not realized the need to provide a sophisticated system to access and promote available technologies.

### SUMMARY OF THE INVENTION

The present invention overcomes the problems outlined above and provides a web-based application system for the entrepreneurial and venture capital community that acts as a beacon of interactive knowledge-bases, business tools, databases and smart connectivity tools for a local community, and with connection to a series of other local communities whereas to create a virtual network.

It is another object of the invention to provide a smart profiling, mapping and matching platform for investment and strategic alliance opportunities allowing a maximum systematic approach to match needs with capabilities.

It is yet another object to provide a system to present an interactive systematic approach to draw from and present technology transfer elements from the public and private academic institutions as well as the private business sector.

It is yet another object to provide an interactive systematic approach for creating a series of business planning and operational tools that offer a dynamic electronic process, peer review and access.

The web-centric application would be accessed either via an intranet, extranet, or Internet by its participants within the entrepreneurial and venture capital community. The application would provide a series of interactive tools that are useful for each main user; entrepreneurs, investors and corporate alliances, and, professional services and academic institutions. For example, the entrepreneur may interact with a business planning tool questionnaire that automatically populates a pre-scripted narrative form that is available to download or access electronically, that also may be subjected to a predetermined rating system. It may include a posting system for entrepreneurial companies to highlight their needs within the member-base. Another example may include a profile form that the investor completes to use as an electronic search engine that will map and match to potential investment opportunities. The application further includes a comprehensive knowledge-base that pertains mostly to a particular area of concern for the main users; for example, it may include information specific to a strategic or operational need of an entrepreneurial company such as educational materials or directories of services. It also includes logic to transform key information from a sponsor or advertiser into a pre-scripted format that identifies information pertinent to the other users, and logic to profile, map and match needs to capabilities. It may also include a series of operational company functional utilities; for example, a recruiting system, an auction site, and, an interactive management system filled with static information and dynamic applications.

The application and logic is to provide the main users within the entrepreneurial and venture capital community a web-assisted beacon, or go-to site, that can be easily accessed and provide an interactive opportunity to find pertinent and real-time information to its users, within its local virtual community and extending and connecting to a series of other local virtual communities. These local communities may utilize some form of common word denominator within their name in order to create a branding familiarity function.

### BRIEF DESCRIPTION OF THE DRAWINGS

These and other features, aspects and advantages of the present invention will become better understood with reference to the following description, appending claims, and accompanying drawings where:

FIG. 1 illustrates the model of an exemplary embodiment;

FIG.1a illustrates a diagram of accessing and utilizing the system;

FIG. 2 illustrates the problem with the existing state of field affairs;

FIG. 3 illustrates the main solution of exemplary embodiment;

FIG. 4 illustrates the applications of an exemplary embodiment;

FIG. 5 illustrates the consolidation model of an exemplary embodiment;

FIG. 6 illustrates the members and products of an exemplary embodiment;

FIG. 7 illustrates the connection of a parent to a local community of an exemplary embodiment;

FIG. 8 illustrates a hierarchy of local community connections to the parent of an exemplary embodiment;

FIG. 9 illustrates a grouping of domain names for the parent and local communities of an exemplary embodiment;

FIG. 10 illustrates the home page of a parent or local community website of an exemplary embodiment;

FIG. 11 illustrates a website map of a parent or local community website of an exemplary embodiment;

FIG. 12 illustrates another website map of a parent or local community website of an exemplary embodiment;

FIG. 13 illustrates yet another website map of a parent or local community website of an exemplary embodiment;

FIG. 14 illustrates a set of product tools for the entrepreneurial company of an exemplary embodiment;

FIG. 15 illustrates an interactive business planning tool that automatically populates a narrative script of an exemplary embodiment;

FIG. 16 illustrates a flow chart describing the interactive dynamic mentoring and review/rating process of the entrepreneurs completed business planning tools of an exemplary embodiment;

FIG. 17 illustrates a diagram of potential members of an advisory council that review the process identified in FIG. 16;

FIG. 18 illustrates a flow chart describing the interactive process for accessing intellectual capital of an exemplary embodiment;

FIG. 19 illustrates a diagram of various interactive operational business tools, guidelines and applications for entrepreneurs of an exemplary embodiment;

FIG. 20 illustrates a diagram of an interactive management system (e.g. CEO Mentor) for entrepreneurs of an exemplary embodiment;

FIG. 21 illustrates a diagram of an interactive local community member base of an exemplary embodiment;

FIG. 22 illustrates an interactive business resource listing of an exemplary embodiment;

FIG. 23 illustrates a diagram of an interactive local community University/College member base of an exemplary embodiment;

FIG. 24 illustrates a diagram of an interactive local community economic development member base of an exemplary embodiment;

FIG. 25 illustrates a diagram of a website page containing a mini-website of a local community economic development agency of an exemplary embodiment;

FIG. 26 illustrates a listing by member discipline of specific interactive content;

FIG. 27 illustrates a flow chart of interactive access to Technology Transfer, using the public academics as an example, but could be private as well, private and public business, or individuals of an exemplary embodiment;

FIG. 28 illustrates a diagram of technology transfer and other content using a University as a resource example of an exemplary embodiment;

FIG. 29 illustrates a diagram on a local community website showing their content to other users of an exemplary embodiment;

FIG. 30 illustrates an interactive questionnaire listing that profiles the users, showing an investor as example, to electronically map and match their needs to capabilities of an exemplary embodiment;

FIG. 31 illustrates an interactive posting board of available business opportunities within the member-base and that may electronically access other business tools of an exemplary embodiment;

FIG. 32 illustrates a diagram of an interactive local community accessing system to a variety of entrepreneurial company posting levels of an exemplary embodiment;

FIG. 32a illustrates a diagram of the posting system of an exemplary embodiment;

FIG. 33 illustrates a diagram of entity components of the system of an exemplary embodiment; and

FIG. 34 illustrates a diagram of an example of a community venture capital fund structure of an exemplary embodiment.

### DETAILED DESCRIPTION OF EXEMPLARY EMBODIMENTS

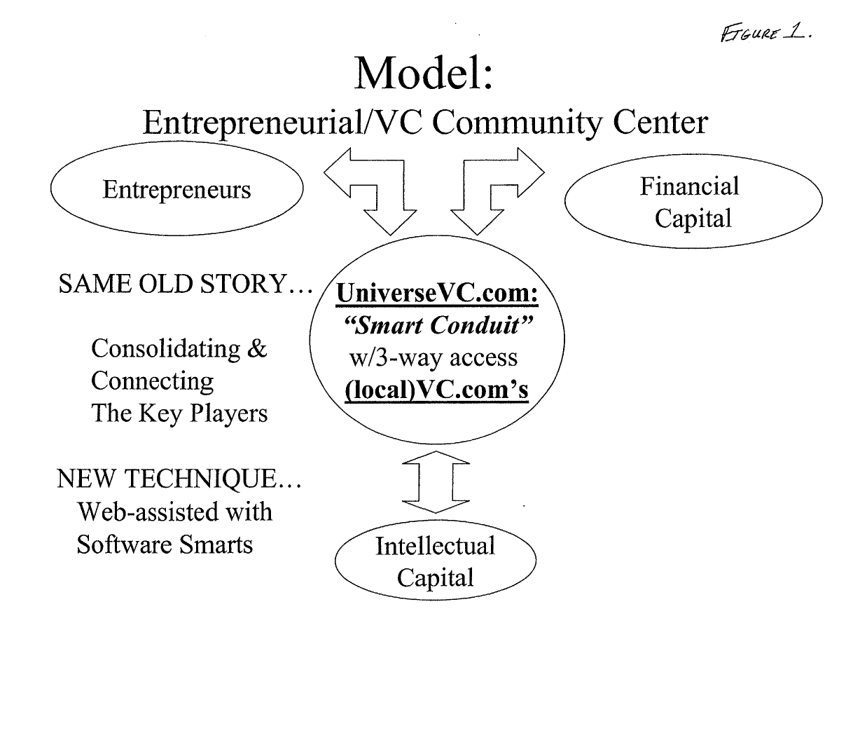

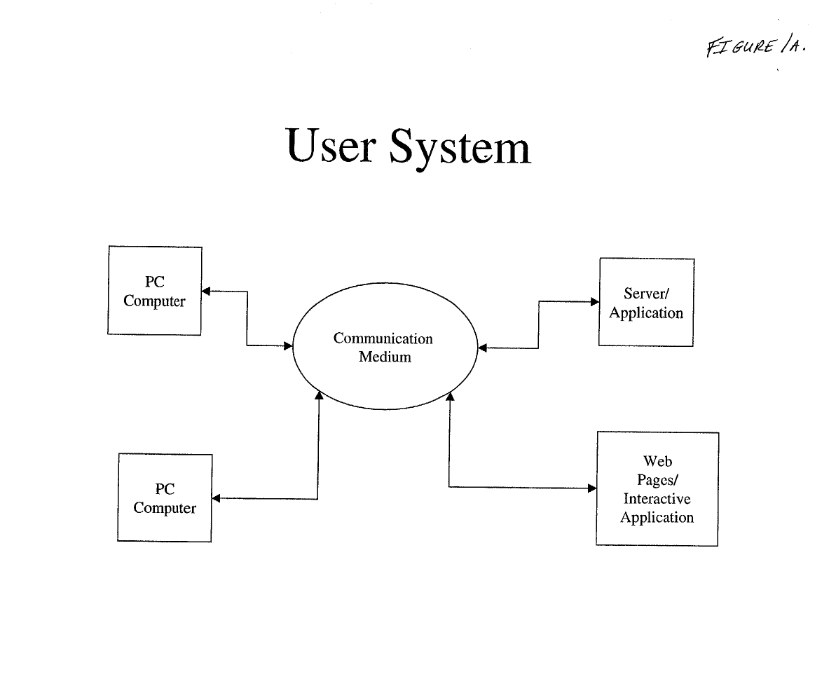

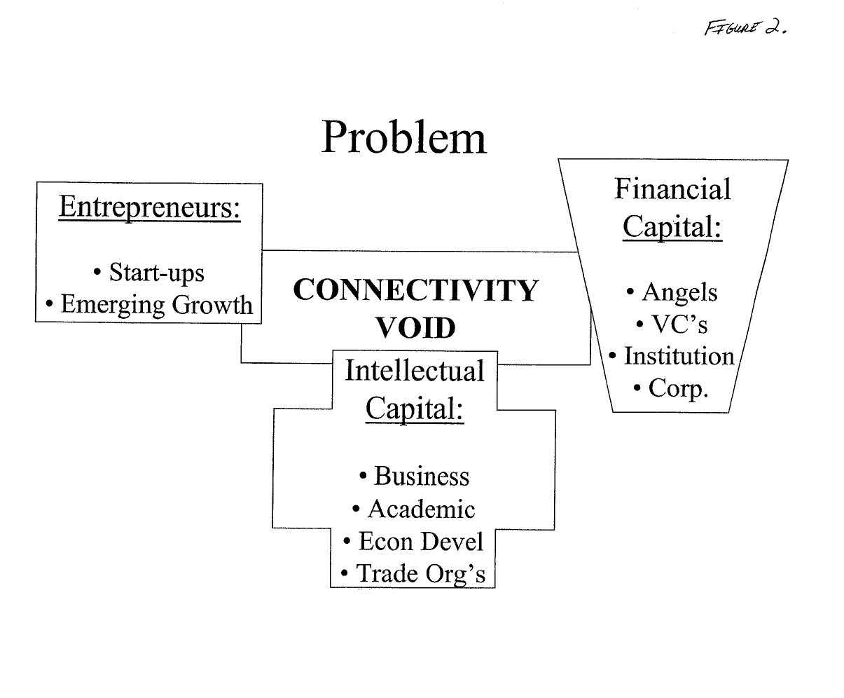

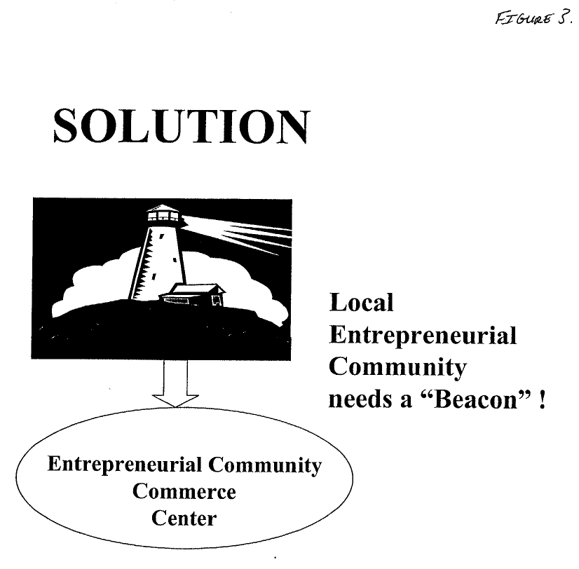

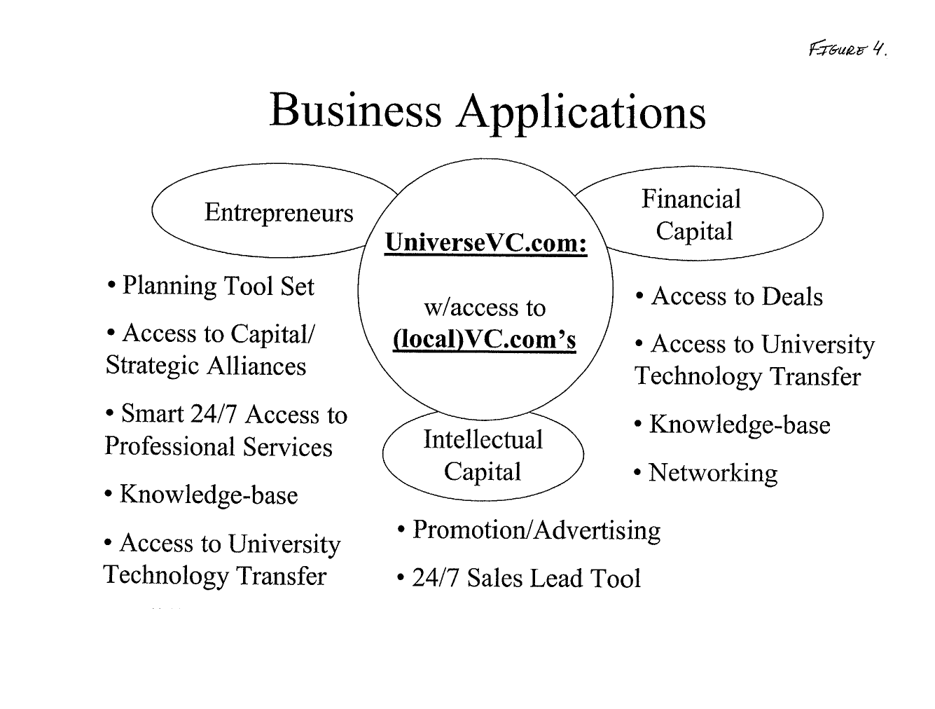

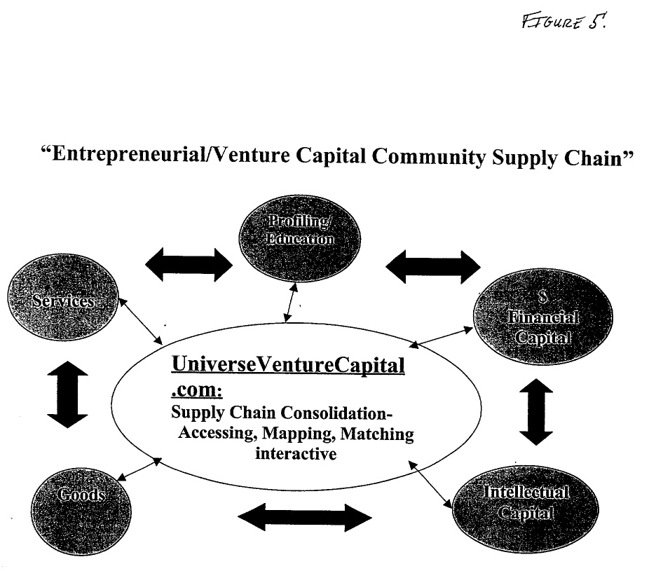

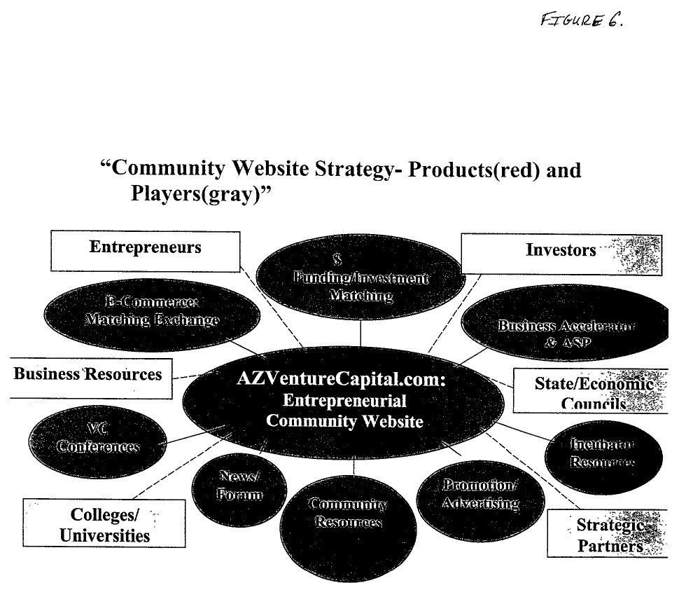

The present invention is particularly suited for use in connection with new and existing venture acceleration, and more particularly to a web-based process for venture resource, mapping, and matching of companies and capital, to include but not limited to, financial and intellectual capital (FIG. 1). As a result, the preferred exemplary embodiment of the present invention is described in that context; and the problem and solution are identified (FIGS. 2, 3). It should be recognized, however, that such description is not intended as a limitation on the use or applicability of the present invention, but is instead provided merely to enable a full and complete description of preferred embodiments (FIGS. 4, 5, 6).

A system according to various aspects of the present invention comprises at least one access terminal having a display and input means (FIG. 2). The terminal is suitably linked to a communication channel for intranet/extranet or Internet access to a web site. A server stores a web site and a computer program in accordance with the present invention. In a preferred embodiment the application is capable of including proactive electronic alerts according to the preference of the user and administration in order to act as a prescribed notification system.

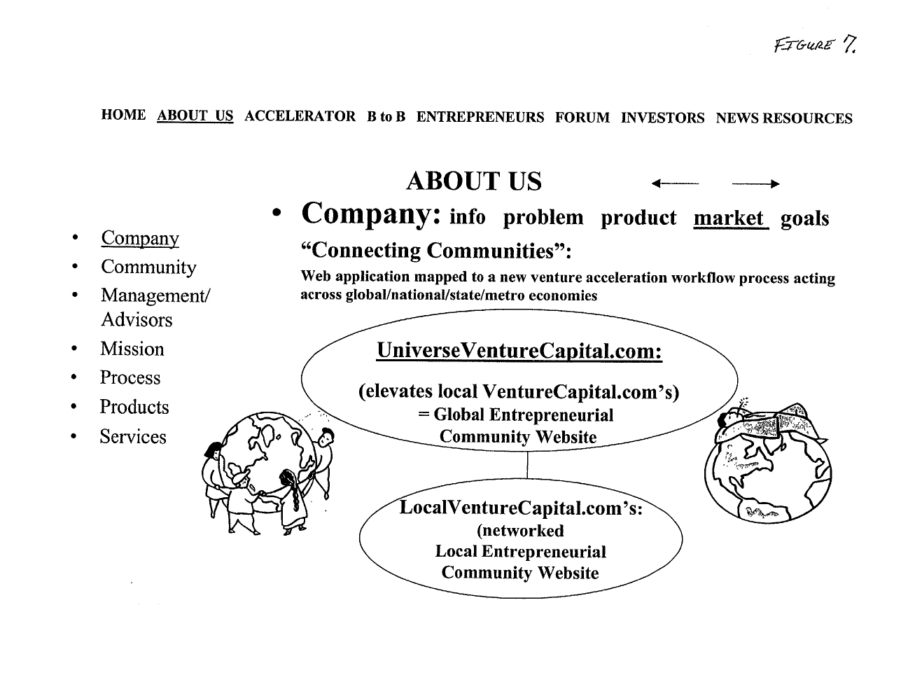

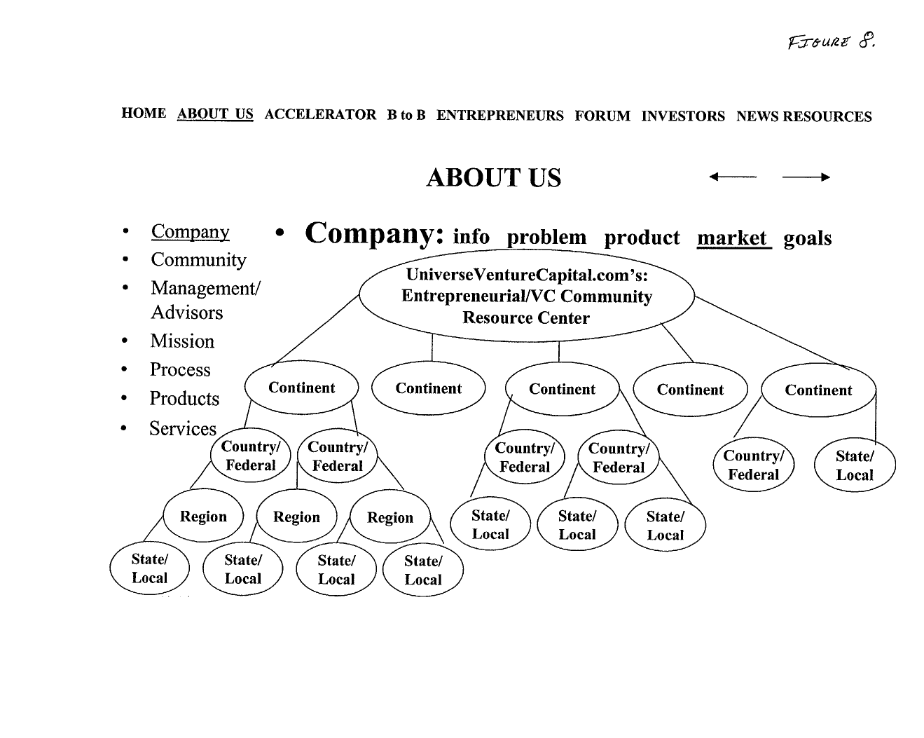

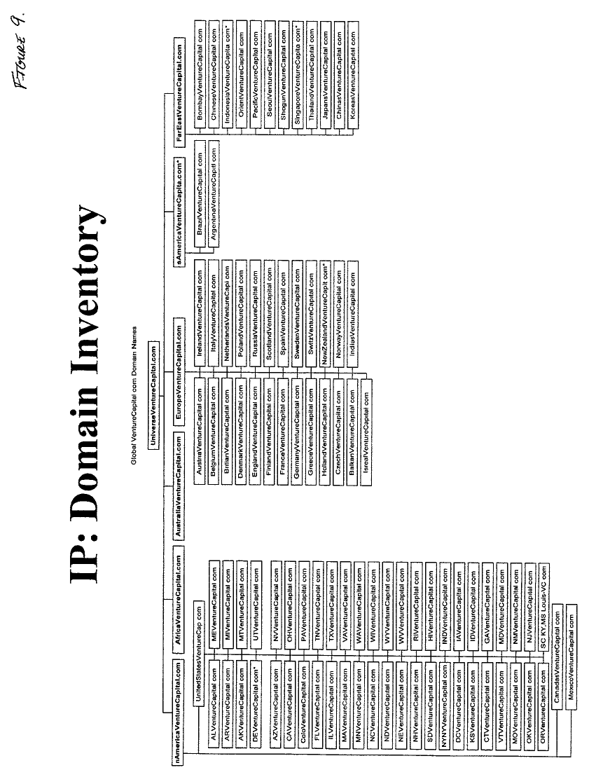

The system is intended to formulate one or a series of individual virtual local communities that may be connected to one another. In a preferred embodiment, the system may call for a central entity (e.g. global parent website) to be the hub of all the local nodes, whereby they can be accessed individually or by an interactive preference method (FIGS. 7, 8), and have isolated private storage space for the users. These nodes would develop a family of similar offerings and would enable user access throughout the entire system (FIG. 9).

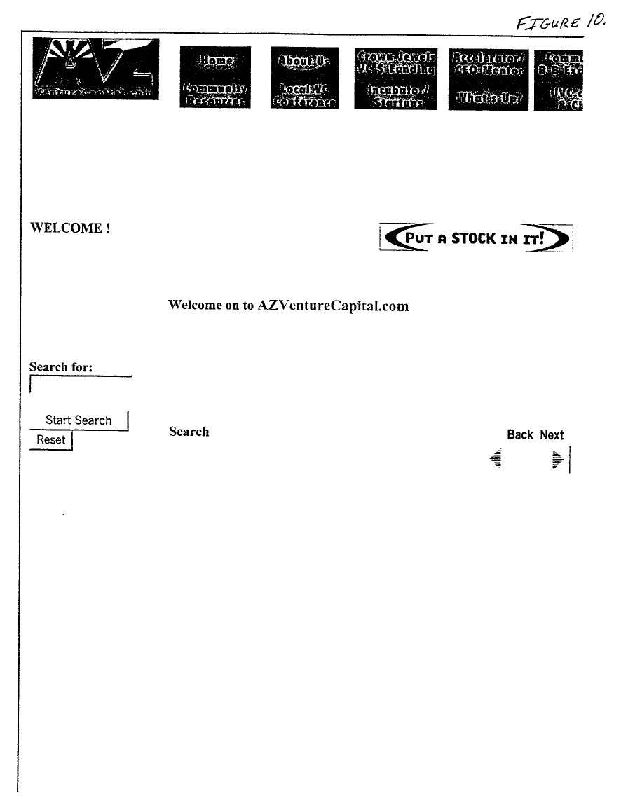

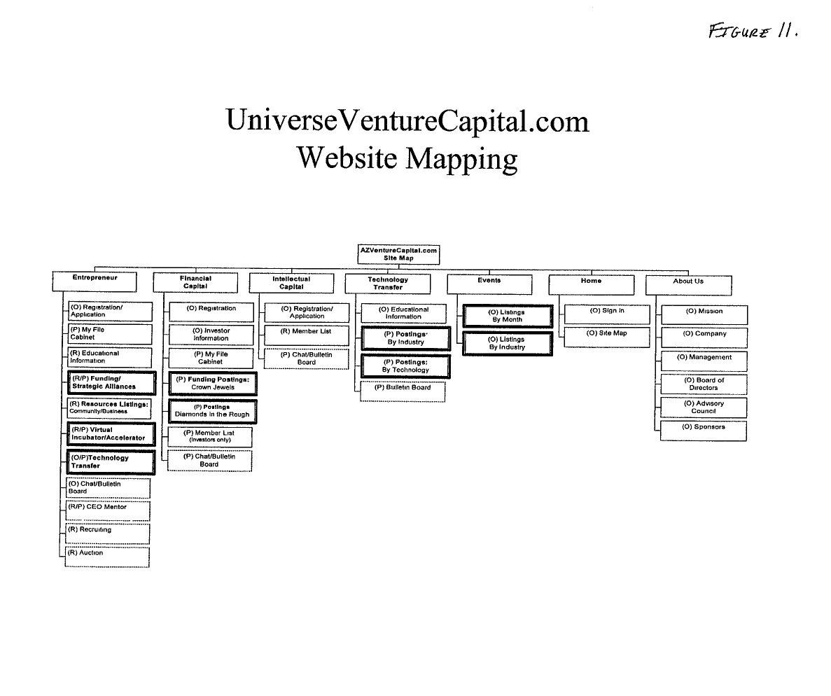

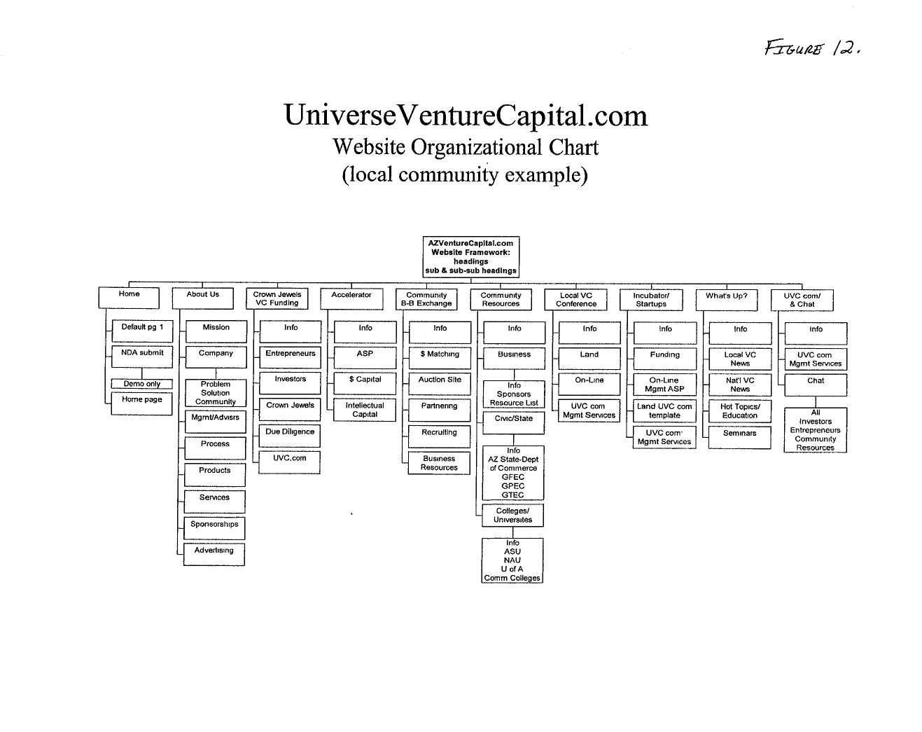

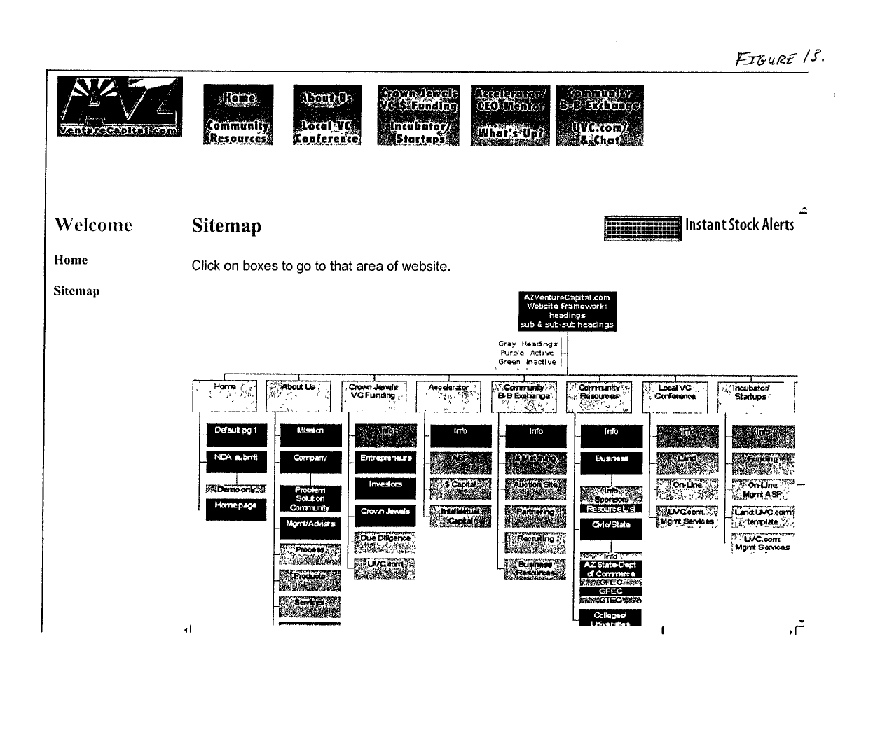

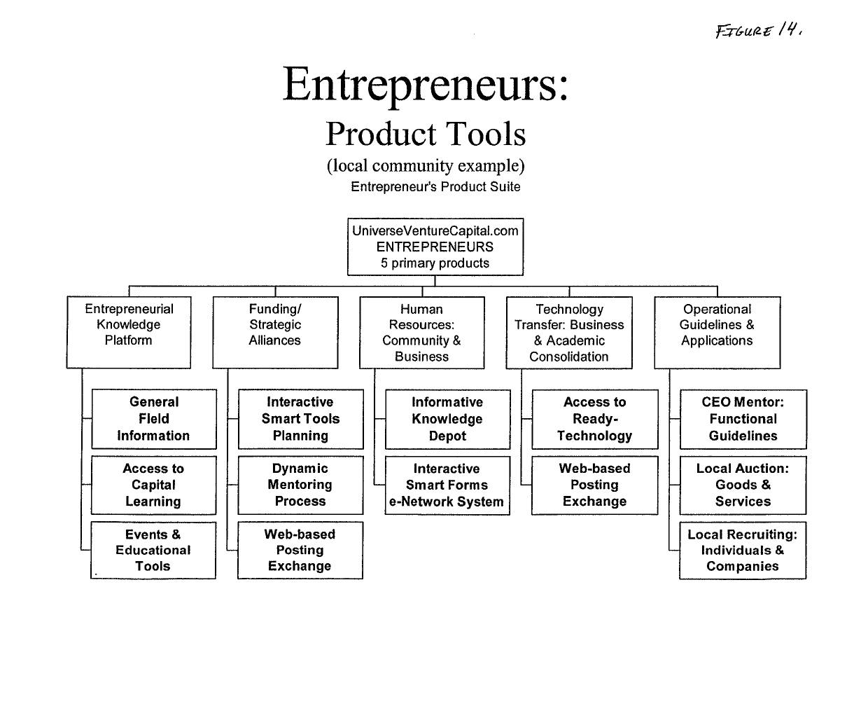

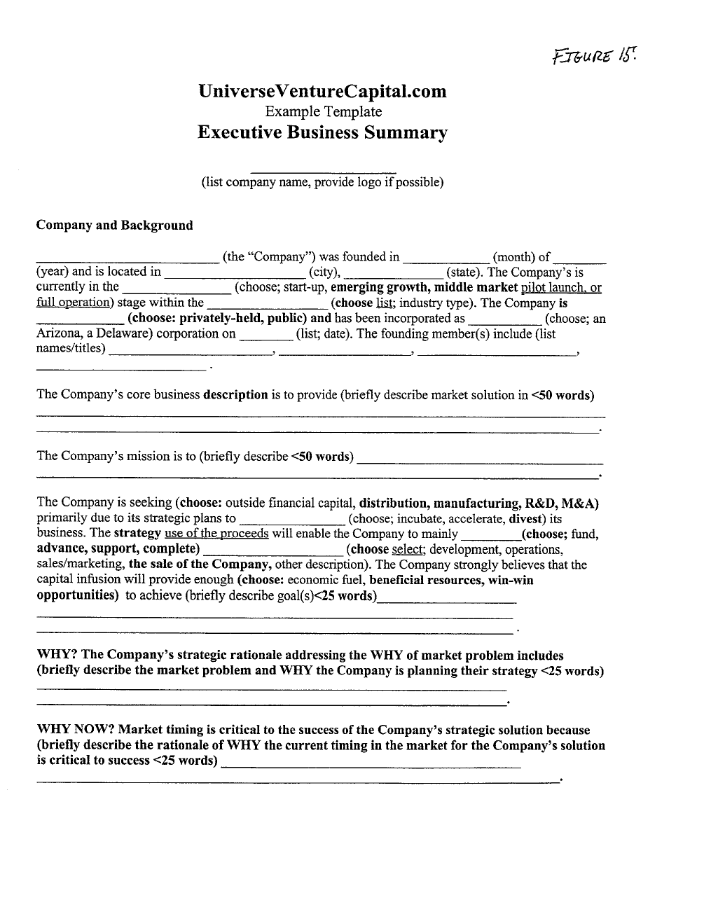

The system further includes a web-based application for venture incubation and acceleration, resource and information (FIGS. 10, 11, 12, 13). In an exemplary embodiment, a user, for example, an entrepreneur in a start-up company, accesses the web-site from a suitable terminal having an Internet access (FIG. 14). The program provides the entrepreneur with a unique login/password. The program prompts the entrepreneur to complete an online questionnaire (FIG. 15) of business planning and management tools (e.g. executive business summary, business plan, typical slide road show, strengths weaknesses opportunities and threats analysis). The program receives the data input and stores the data in a server database (FIG. 1a). In another exemplary embodiment, the program retrieves the stored input data and populates a table showing the business characteristics (e.g., strengths, weaknesses, opportunities, threats) of the company. This information can be accessed electronically, via the intranet/extranet/internet, and downloaded into hard copy from their said isolated private storage space.

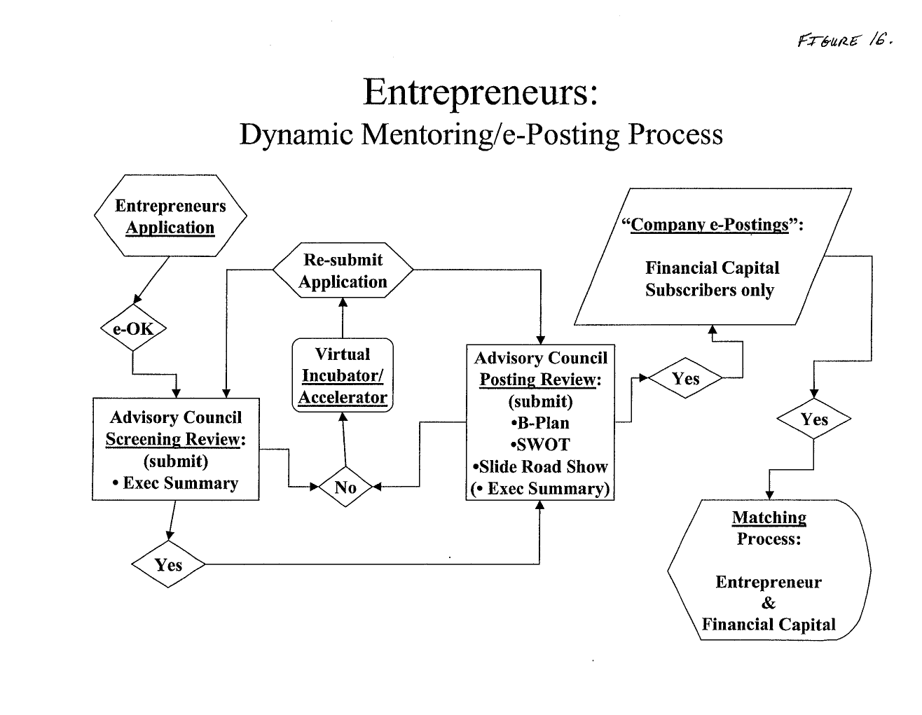

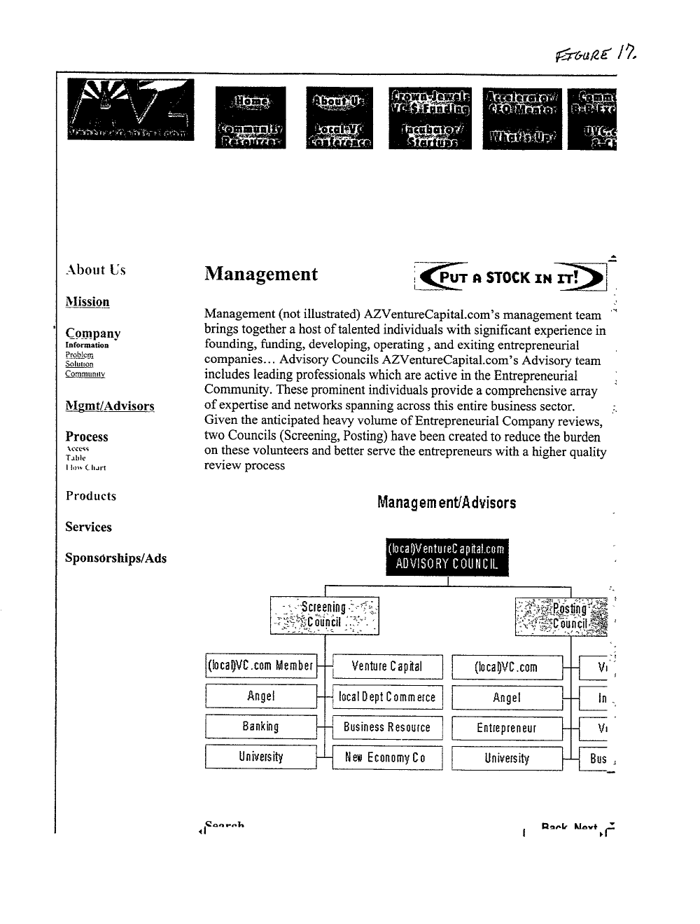

The program is suitably configured to “rate” the entrepreneurial user from the input data. For example, in a preferred embodiment, the data entered on the questionnaire is used to give the entrepreneur a score determined by a set of algorithms stored on the server or via an on-line interactive human review and scoring process. The score may include, but is not limited to, the strength of the start-up business with respect to product, resources and business opportunity, and may be a numerical value, for example, between 1 and 100. Also, the system is designed to allow for peer review recommendations to facilitate input regarding opportunities to enhance the entrepreneurial companies business (FIGS. 16, 17). In another embodiment, the questionnaire is made available for viewing by another user accessing the web-site to further analyze and review the score.

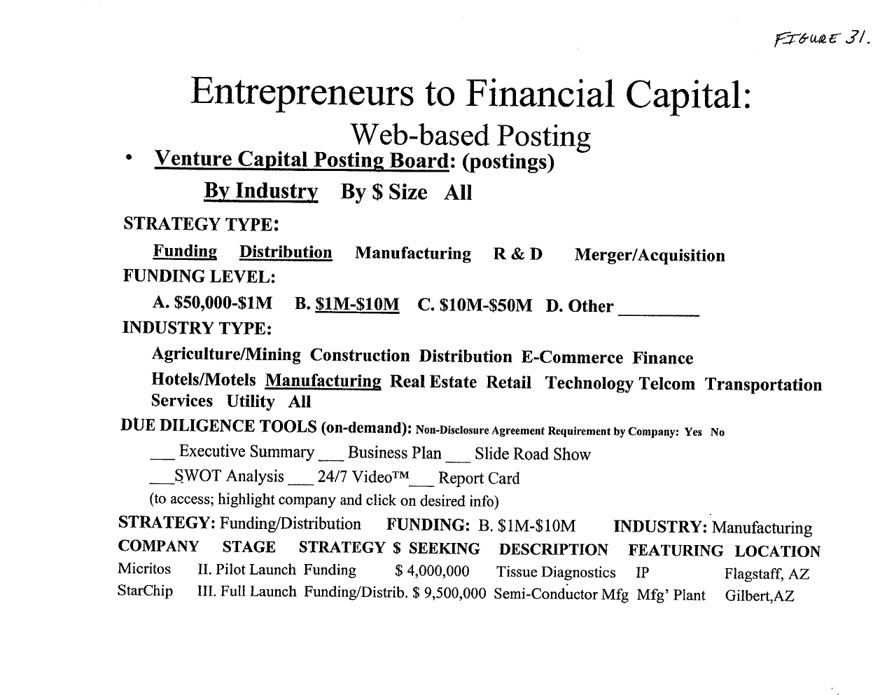

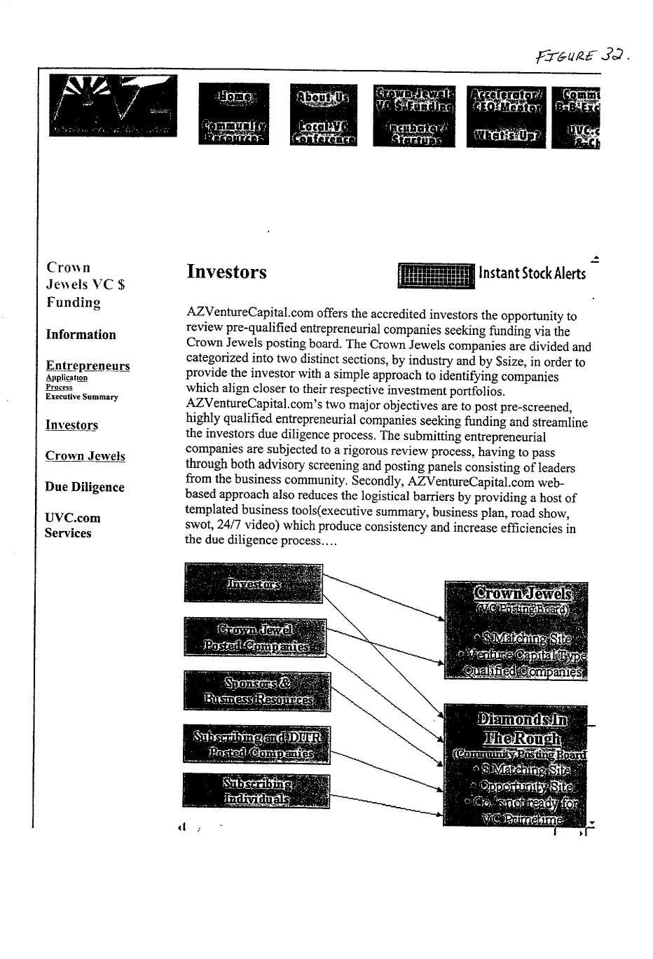

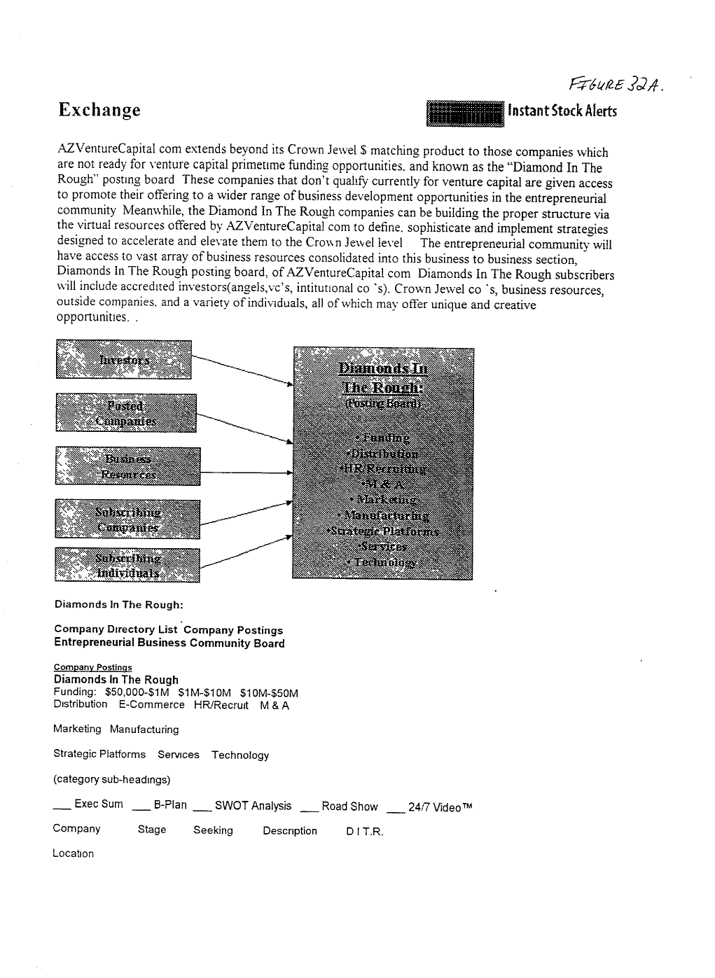

Upon determination of the score, the entrepreneurial start-up company is automatically routed within the system to be placed on a list with other companies having similar scores. For example, a high score may place the company on a list with other companies that are ready to be matched with capital and a low score may place the company on a review and consulting list (FIGS. 31, 32).

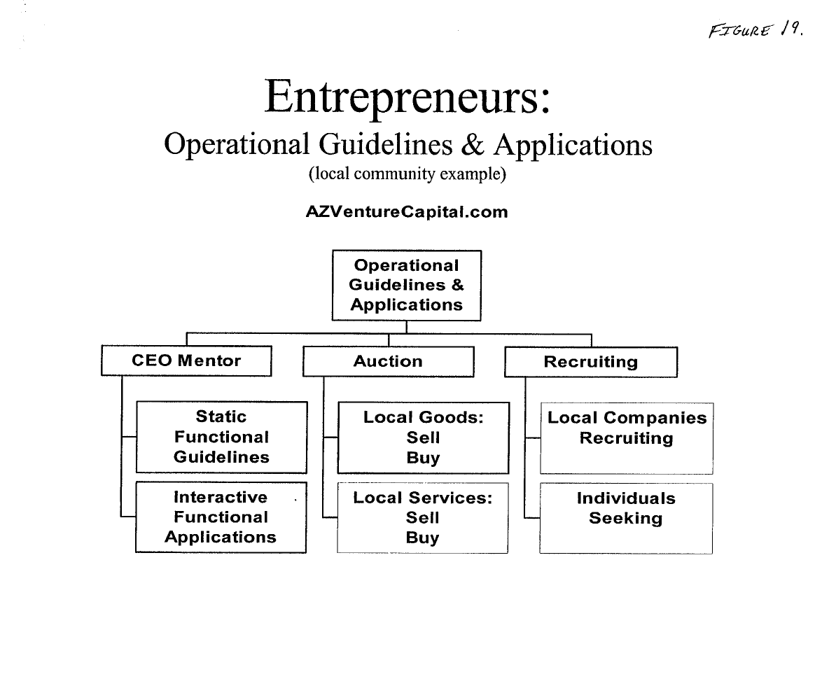

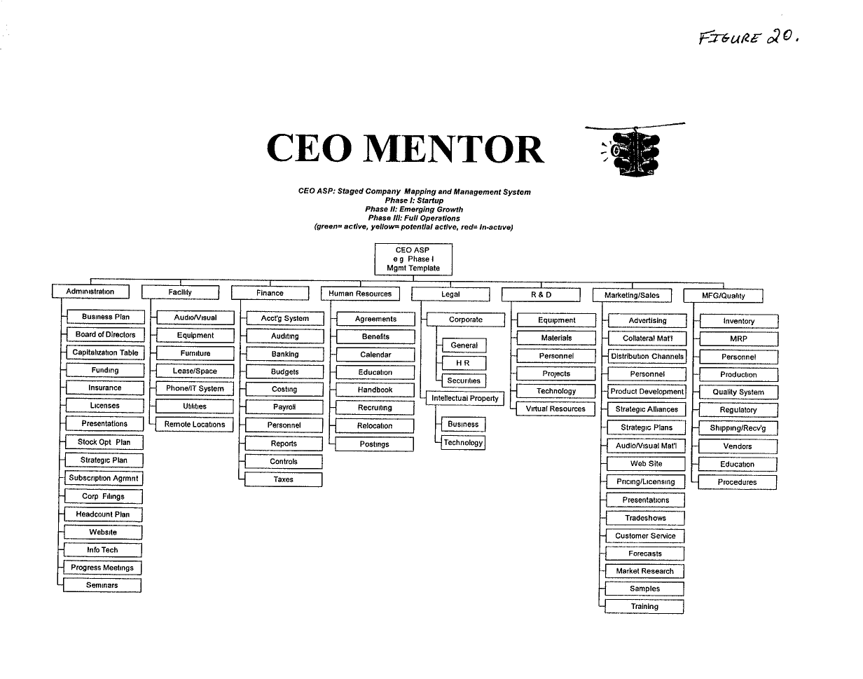

A company may need additional help, guidance and management. The system provides the company with an interactive roadmap designed to grow the company (FIGS. 19, 20). For example, in one embodiment, the system offers a company classification system to coordinate the development stage of the company. In another embodiment, the system highlights the company's departmental and functional areas while featuring strategic guidelines to execute within its staff. Additionally, the system provides a unique profile to match the capabilities and opportunities for a possible strategic partnering. In yet another embodiment, the company can choose from a plurality of options on the web site (e.g., administration, facility, finance, human resource, legal, research and development, marketing and quality) to prepare the company for access to capital.

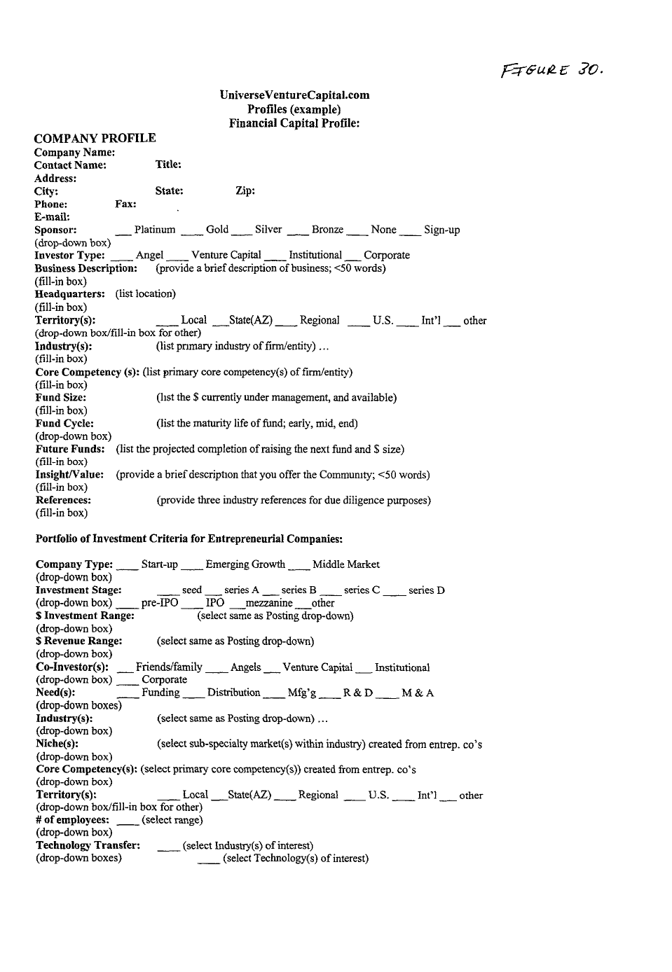

The system of the present invention further includes a web-based application for matching entrepreneurial companies with capital, for example, financial capital and intellectual capital. In a preferred embodiment, capital providers, such as investors, access the web site and are prompted to complete a questionnaire similar to the one previously disclosed (FIG. 30). The program stores the data entered by the investor on the server. In an exemplary embodiment, the program determines the investor in a similar manner as disclosed for the company-user. Depending upon the classification, the investor's access to view the company lists/postings may be limited (FIGS. 31, 32). These postings would create a mechanism similar to an exchange (FIG. 32a) specific to the said entrepreneurial and venture capital community resource center. In a similar preferred embodiment, access to needs and capabilities are offered for matching to distribution, manufacturing, research and development, and mergers and acquisitions requirements. Again depending upon the rating, the investor's access to view the company list may be limited.

In another embodiment, the system facilitates company due diligence. An exemplary embodiment allows the capital provider to access a “video library” (FIG. 31) on the web site. The video library comprises an audio/visual presentation of users, such as for example, start-up companies. The capital provider selects a presentation to view, such as a presentation from an entrepreneur the provider is interested in doing business with, then the presentation is retrieved from the server and displayed for the capital provider.

In yet another embodiment, and as part of the company due diligence process system, the capital provider can view information stored on the server for a particular company relating to, for example, the data entered by the company. In yet another embodiment, the capital provider may make a message request for additional information on a company and request a conference. In accordance with the present invention, a conference over the Internet is held using a computer microphone, suitable sound speakers, an access terminal and an Internet connection. Thus, the program is suitably configured to allow the capital provider and the entrepreneur to engage in a real-time audio or audio/video conversation via the Internet connection.

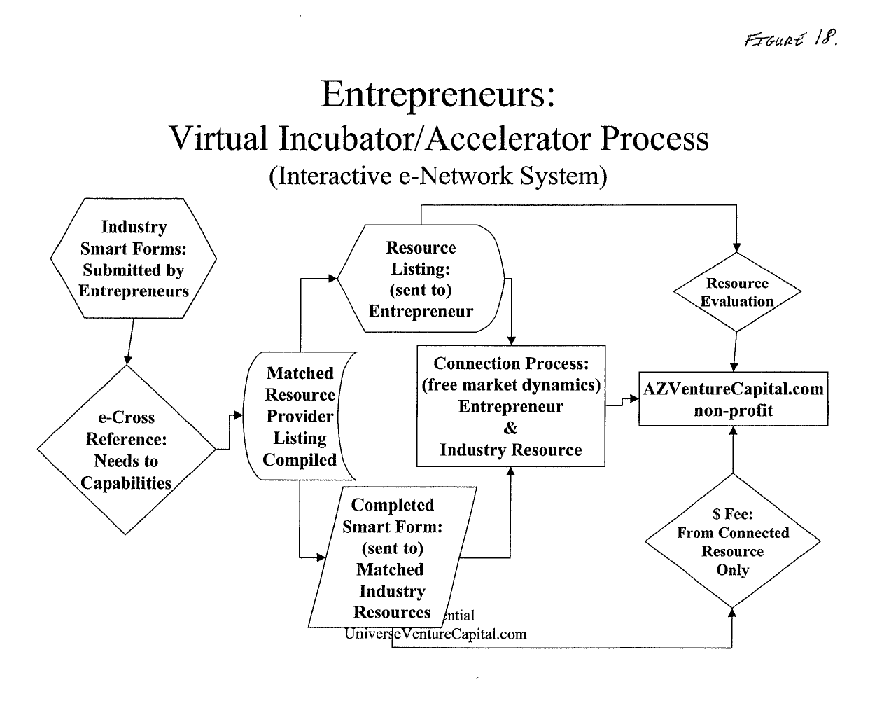

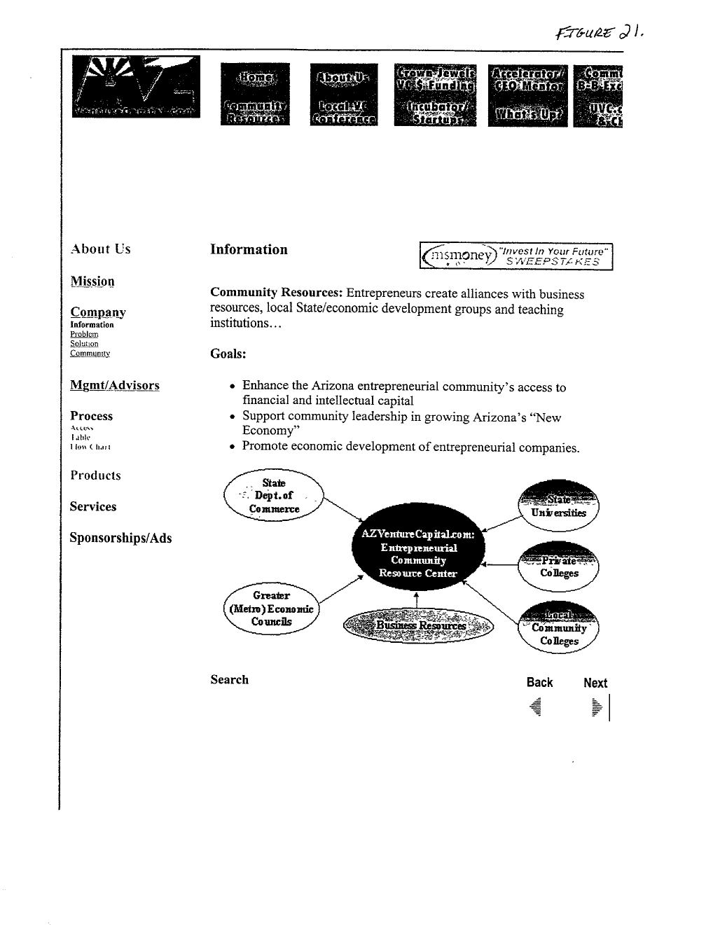

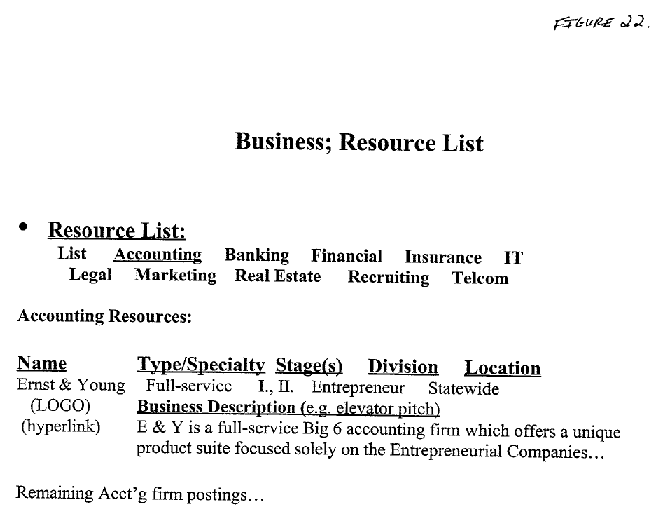

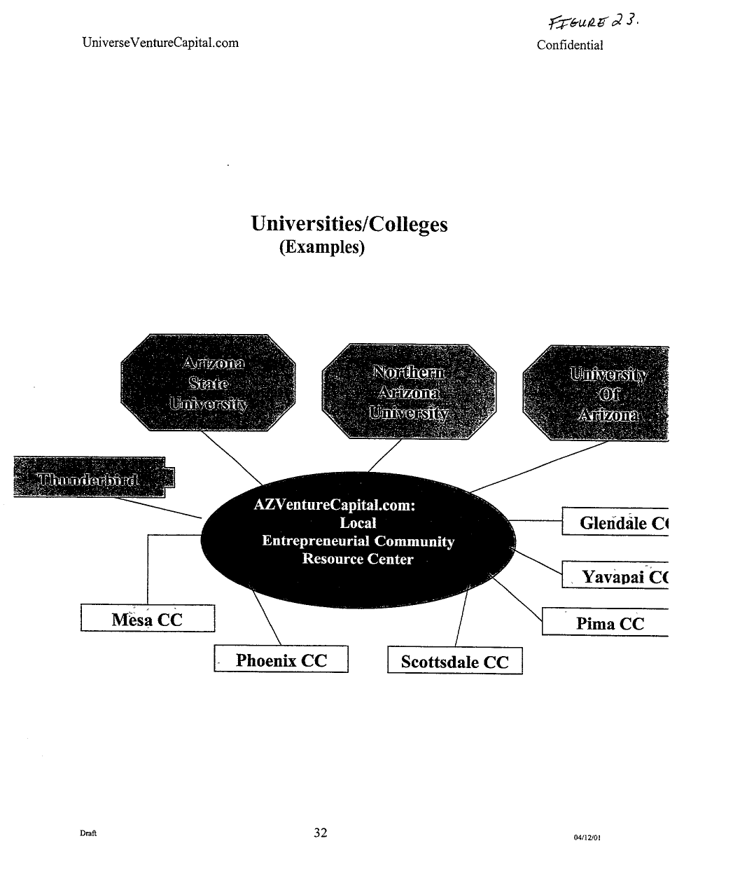

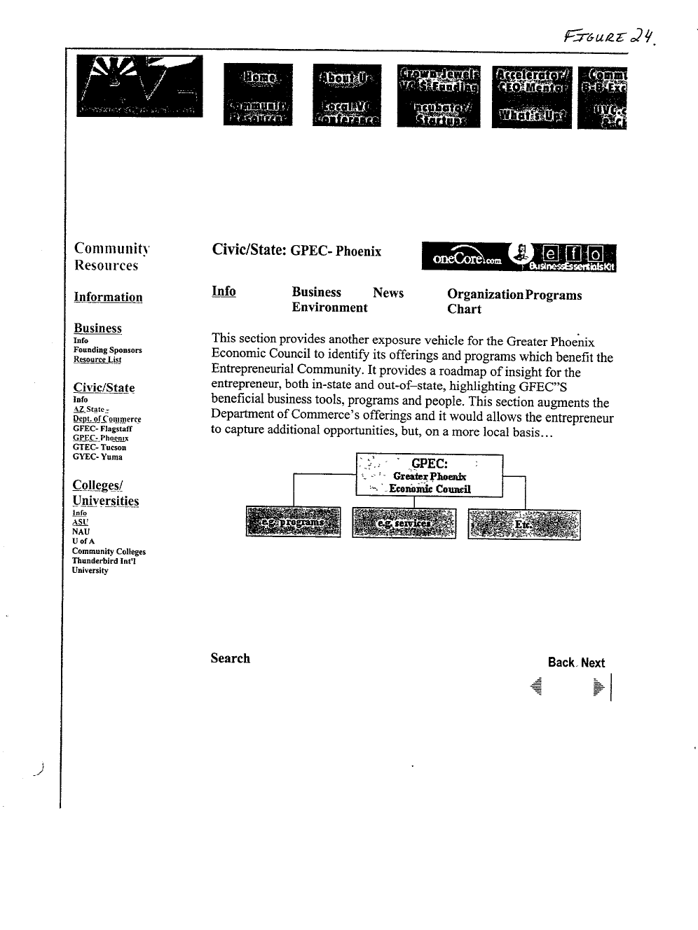

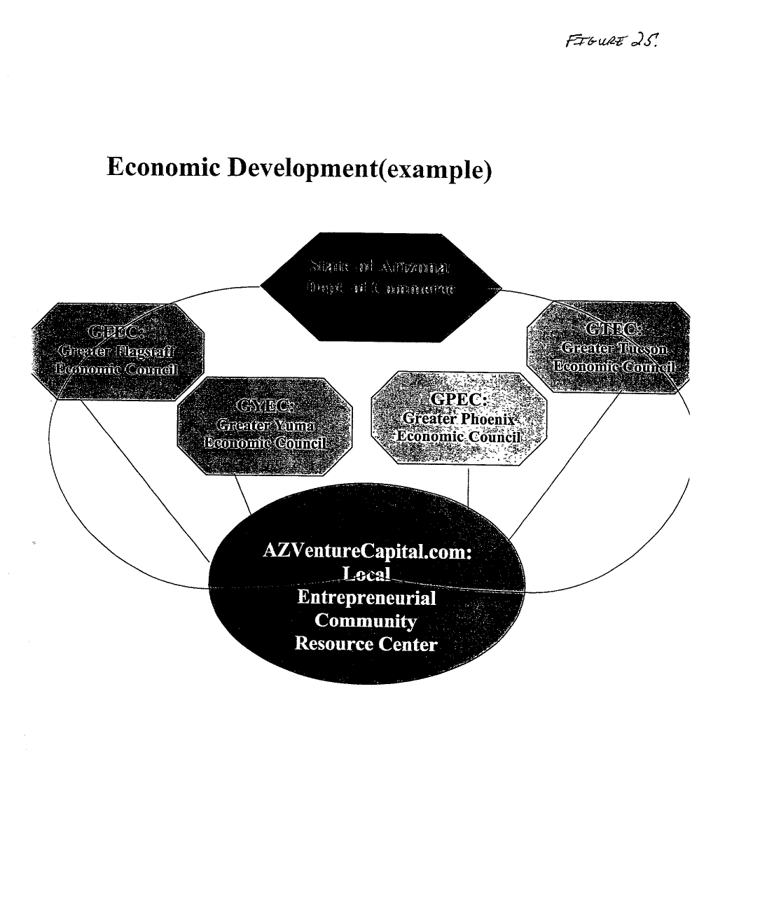

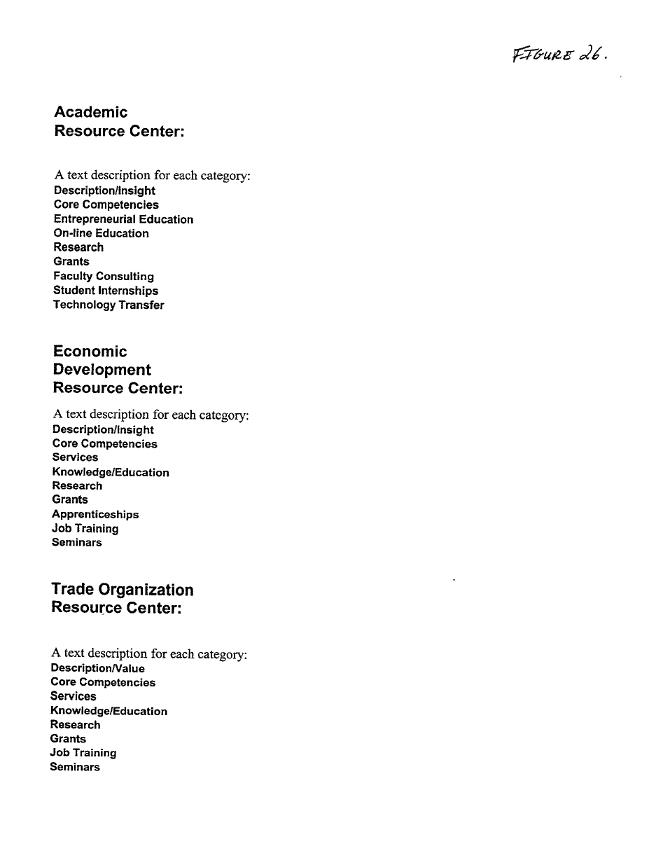

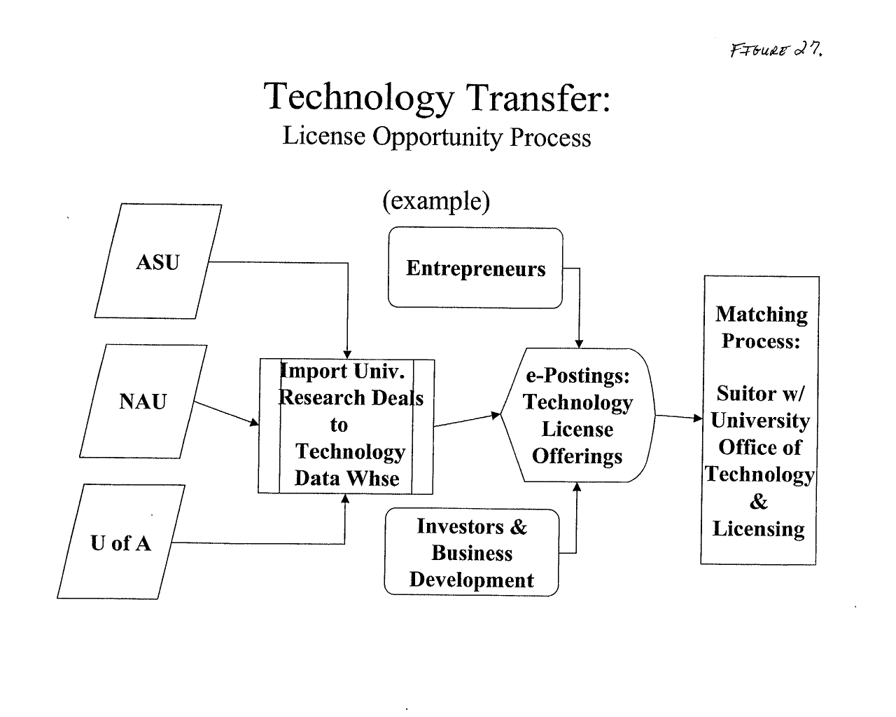

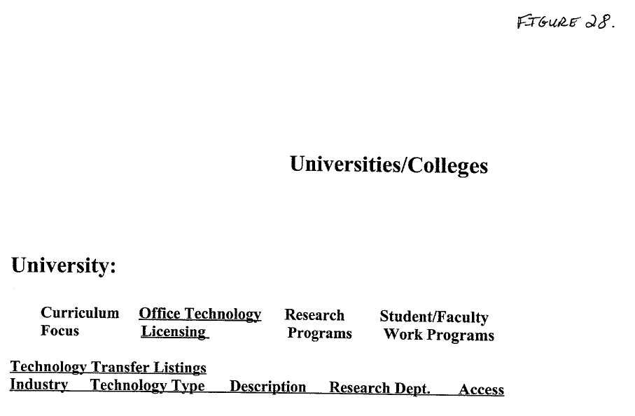

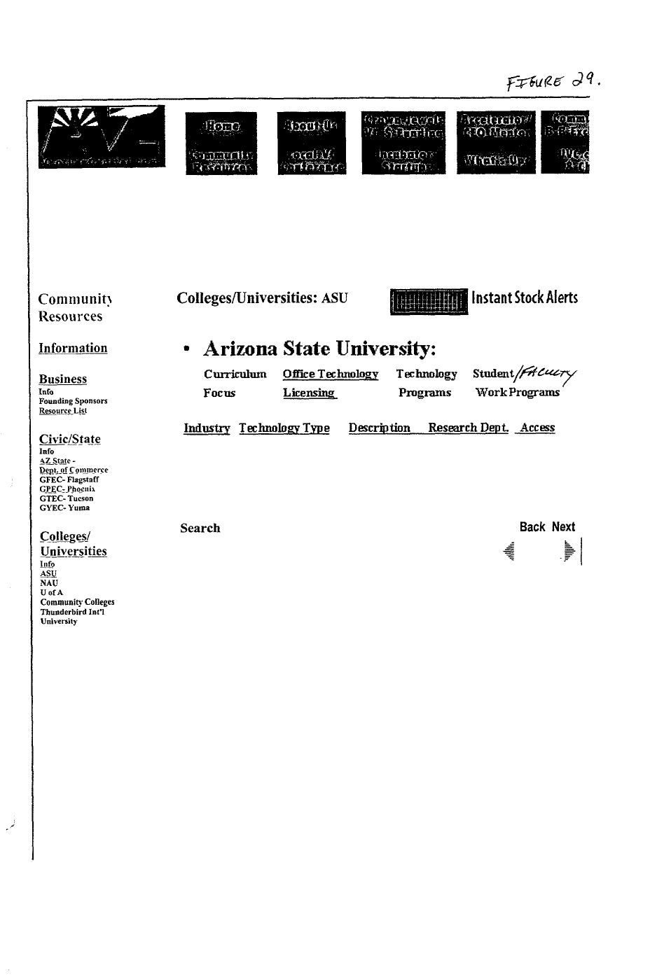

The system further provides a user (e.g., entrepreneurial start-up company) an opportunity to create alliances with community resources (FIGS. 18, 21, 22, 26), such as for example, local state departments, economic development agencies, colleges and universities, trade organizations and local business resources, (FIGS. 23, 24, 25, 29). The user can view stored information on each community resource to gain insight on such listings as state programs, student work groups, licensing opportunities, and other information and knowledge that is pertinent to a business. In a preferred embodiment, the program is a distribution tool by linking users to resources both within and outside the web-based system. In another preferred embodiment, access to Technology Transfer from public and private Academic Institutions, businesses, and individuals may be gained by qualified users (FIGS. 27, 28, 29). The system provides and opportunity for the user to electronically access available technologies from a variety of connected resources.

The system, in accordance with a preferred embodiment, provides an opportunity for the user (e.g., entrepreneurial start-up company) to define, sophisticate and implement strategies designed to accelerate and elevate the company for access to capital (FIG. 19). In an exemplary embodiment, the company has access to array of on-line business resources, recruiting, management and acceleration programs and opportunities. In yet another embodiment, the company can liquidate and acquire goods or services from an auction site.

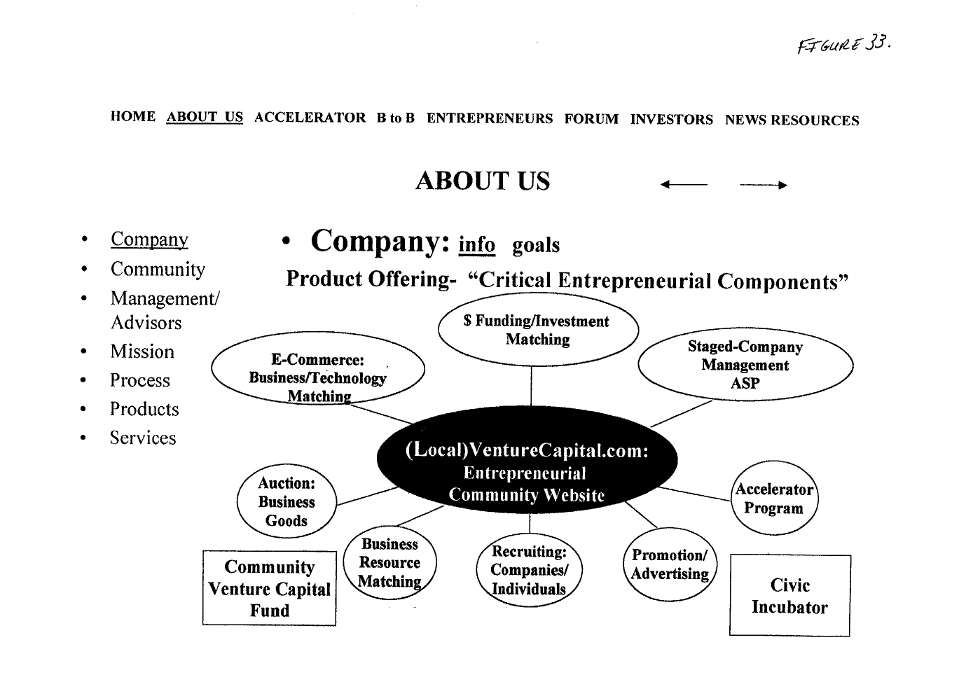

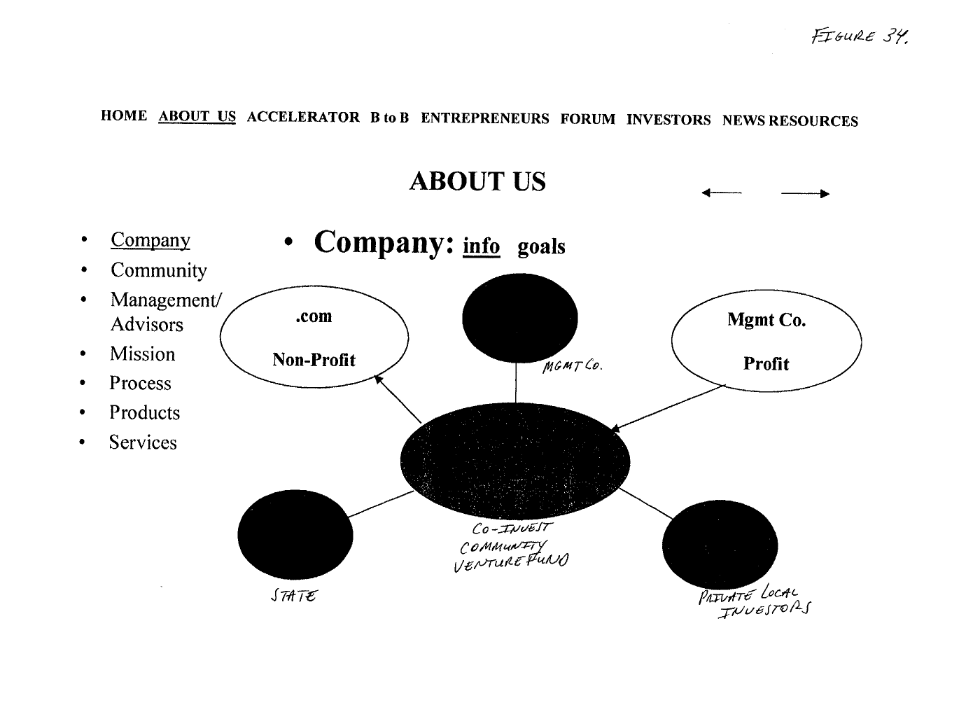

In yet another embodiment, the model is capable of including a variety of business components to expand its offering of the said web-assisted entrepreneurial and venture capital community resource center. These components would include the addition of a civic or private incubator or accelerator (FIG. 33), and a Community venture capital fund with combined contributions of future determined levels (FIG. 34).

In a preferred embodiment, all or any portions of the web-centric application can be used together or separately. Individual parts may be used to serve as their own identity but, with a similar delivery method.

### Mode of Operation

The best mode of operation is a combination of a web-centric interactive application and manual land modalities. The facilitation of the business method is best executed by an interactive on-line system that is administered manually.

1. A method using web-assisted application as an entrepreneurial and venture capital community resource and collaboration center and portal for venture incubation and acceleration; the system is provided by the use of a local computer terminal that accesses the web site via an intranet/extranet/internet connected to a web-server.

2. A web-based method for formulation of at least one node known as local virtual community, and said node is replicated through a central entity and capable of being linked to another node in claim 1.

3. A web-based method for entrepreneurs to access capital (financial and intellectual) and to enhance their business through interactive predefined business planning and operational/management tools, needs posting system, knowledge-base, collaboration, and with proactive electronic alerts.

4. A web-based method to access and promote an interactive management system (CEO Mentor) that offers a systematic guideline for strategic and operational/functional entrepreneurial company needs, and through their lifecycle stages in claim 3.

5. A web-based method for investors to access venture deals, enhance knowledge and expand networks though an interactive profiling, mapping and matching of entrepreneurial company needs to investment capabilities, knowledge-base, collaboration, and with electronic proactive alerts.

6. A web-based method to access and promote technology transfer through interactive promotion, and profiling, mapping and matching to and from public and private academic institutions, to and from public and private businesses, and with an electronic proactive alerts, in claim 1.

7. A web-based method to access and promote mergers and acquisitions interactive promotion, and profiling, mapping and matching to provide capabilities to serve entrepreneurial company needs, and with proactive electronic alerts in claim 5.

8. A web-based method for academic institutions and trade organizations interactive promotion, and profiling, mapping and matching to provide capabilities to serve entrepreneurial company needs in claim 1.

9. A web-based method for professional services interactive promotion, and profiling, mapping and matching to provide capabilities to serve entrepreneurial company needs in claim 1.

10. A web-based method for economic development organization interactive promotion, and profiling, mapping and matching to provide capabilities to serve entrepreneurial company needs in claim 1.

11. A web-based method for electronic review and rating system of said business planning and operational/management tools in claim 3.

12. A web-based method for interactive electronic recruiting of employers and employees of entrepreneurial companies, and with proactive electronic alerts in claim 3.

13. A web-based method for an auction list and trade goods and services, and with proactive electronic alerts in claim 3.

14. A web-based method for a virtual business incubator and accelerator that provides a step by step process during entrepreneurial companies lifecycles in claim 3.

15. A web-based method for the creation of a video library that promotes a member company's offering of goods and/or services in claim 5.

16. A web-based method for on-line collaboration between users to engage in real-time audio, visual or audio/visual communication in claim 1.

17. A method to include outside entities to the overall system, such as civic and private incubators and accelerators, and, community based venture capital funds in claim 1.
